(19) United States
(12) Patent Application Publication
(10) Pub. No.: US 2015/0100453 A1
(43) Pub. Date: Apr. 9, 2015

(54) COLOR INDICATION

(71) Applicant: Steven Romero, Portland, OR (US)

(72) Inventor: Steven Romero, Portland, OR (US)

(73) Assignee: eBay Inc., San Jose, CA (US)

(21) Appl. No.: 14/049,338

(22) Filed: Oct. 9, 2013

(51) Int. Cl. G06Q 30/06

(52) U.S. Cl. CPC G06Q 30/0631; G06Q 30/0641
USPC 705/26.7

(57) ABSTRACT

A system comprising a computer-readable storage medium storing at least one program and a computer-implemented method for providing applicability indicators using color are disclosed. An applicability indicator may provide a user with an indicator of the applicability of a particular item presented to the user in response to a search query or recommendation. In some embodiments, the method may include accessing a user profile and a set of item attributes corresponding to an item. The method may further include determining an applicability score for the item. A set of color values may be assigned to the item based on the applicability score. An item view interface including the item and an applicability indicator is generated. The applicability indicator may be colored according to the set of color values assigned to the item.

### TECHNICAL FIELD

The subject matter disclosed herein generally relates to data processing. Specifically, the present disclosure addresses systems and methods for providing applicability indicators in an information filtering system.

### BACKGROUND

Traditional web search engines search for information across the World Wide Web in response to user search queries. These web search engines often return a list of results fulfilling the user query. Most search engines employ methods to rank the results so that the results are presented to users in order of relevance. For complex queries, it is often difficult for a user to understand the particular reasons for certain results being returned and why certain results are ranked higher than others.

Similar to web search engines, recommendation engines seek to provide a user with a list of items (e.g., music, books, movies, etc.) or social elements (e.g., people or groups) that may be of interest to users. As with the results provided by web search engines, the results provided by traditional recommendation systems fail to provide users with an understanding of why certain items or social elements are being recommended.

### BRIEF DESCRIPTION OF THE DRAWINGS

Some embodiments are illustrated by way of example and not limitation in the figures of the accompanying drawings in which:

FIG. 1 is a network diagram depicting a network system having a client-server architecture configured for exchanging data over a network, according to an example embodiment.

FIG. 2 is a block diagram illustrating an example embodiment of multiple marketplace and payment applications, which are provided as part of the network system.

FIG. 3 is a block diagram illustrating an example embodiment of multiple modules forming applicability indication applications, which are provided as part of the network system.

FIG. 4 is a flowchart illustrating an example method of providing an applicability indicator for an item.

FIG. 5 is a flowchart illustrating an example method of assigning a set of color values to an item.

FIG. 6 is an interaction diagram illustrating an example method of providing an applicability indicator for a list of items.

FIG. 7 is an interface diagram illustrating a portion of an item view interface, according to an example embodiment.

FIG. 8 is a block diagram illustrating a mobile device, according to an example embodiment.

FIG. 9 is a diagrammatic representation of a machine in the example form of a computer system within which a set of instructions for causing the machine to perform any one or more of the methodologies discussed herein may be executed.

### DETAILED DESCRIPTION

Reference will now be made in detail to specific example embodiments for carrying out the inventive subject matter. Examples of these specific embodiments are illustrated in the accompanying drawings. It will be understood that they are not intended to limit the scope of the claims to the described embodiments. On the contrary, they are intended to cover alternatives, modifications, and equivalents as may be included within the spirit and scope of the disclosure. In the following description, specific details are set forth in order to provide a thorough understanding of the subject matter. Embodiments may be practiced without some or all of these specific details.

In accordance with the present disclosure, components, process steps, and data structures may be implemented using various types of operating systems, programming languages, computing platforms, computer programs, and general purpose machines. In addition, those of ordinary skill in the art will recognize that devices of a less general purpose or nature, such as hardwired devices, field programmable gate arrays (FPGAs), application specific integrated circuits (ASICs), or the like, may also be used without departing from the scope and spirit of the concepts disclosed herein.

Aspects of the present disclosure describe systems and methods for providing applicability indicators using color. An applicability indicator may provide a user with an indication of the applicability of a particular item presented to the user in a list of search results or in a recommendation. In some embodiments, the method may include accessing a user profile and a set of item attributes corresponding to an item. The method may further include determining an applicability score for the item based on information included in the user profile. A set of color values may be assigned to the item based on the applicability score. The set of color values correspond to a set of coordinates in a color space. An item view interface including the item and an applicability indicator is generated. The applicability indicator may be colored according to the set of color values assigned to the item.

In a non-limiting illustrative example, a user may be presented with a list of recommendations for button-up shirts based on the user having added a particular button-up shirt to an electronic shopping cart. Each button-up shirt provided to the user as part of the recommendation may have a respective applicability indicator. The color of each applicability indicator provides the user with information about the applicability of the item to the user. The color of each indicator is based on the similarities between the button-up shirt added to the shopping cart and each respective button-up shirt included in the recommendation. For example, button-up shirts that are the same brand as the button-up shirt added to the shopping cart may have an applicability indicator with a red hue. In another example, button-up shirts that are the same size as the shirt added to the shopping cart may have an applicability indicator with a green hue. In yet another example, button-up shirts that are the same style as the shirt in the shopping cart may have an applicability indicator with a blue hue. Button-up shirts sharing more than one of these attributes with the shirt added to the shopping cart (e.g., same brand and same style, same style and color) may have corresponding applicability indicators with colors that are combinations of red, green and blue.

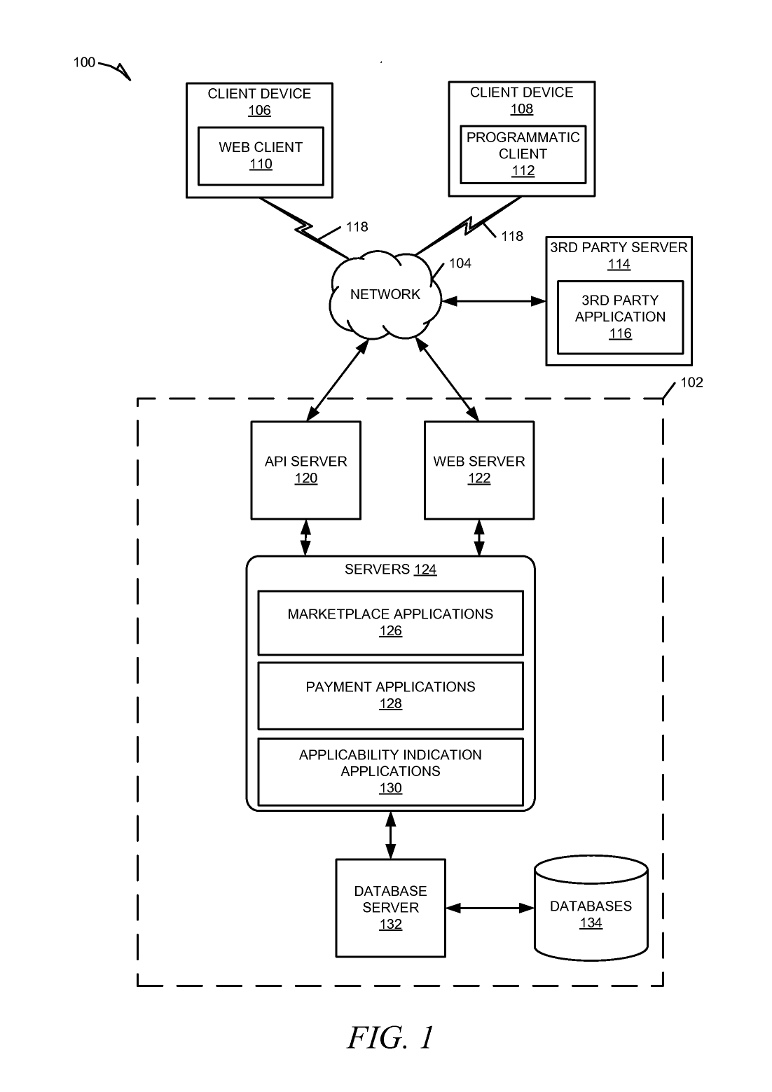

FIG. 1 is a network diagram depicting an example network system 100, according to one embodiment, having a client-server architecture configured for exchanging data over a network. For example, the network system 100 may be a network-based marketplace 102 where clients may communicate and exchange data within the network system 100. The data may pertain to various functions and aspects associated with the network system 100 and its users.

A data exchange platform, in an example form of a network-based marketplace 102, may provide server-side functionality, via a network 104 (e.g., the Internet), to one or more client devices. The one or more client devices may be operated by users that use the network system 100 to exchange data over the network 104. These transactions may include transmitting, receiving (communicating), and processing data to, from, and regarding content and users of the network system 100. The data may include, but are not limited to images; video or audio content; user preferences; product and service feedback, advice, and reviews; product, service, manufacturer, and vendor recommendations and identifiers; product and service listings associated with buyers and sellers; product and service advertisements; auction bids; and transaction data, among other things.

In various embodiments, the data exchanges within the network system 100 may be dependent upon user-selected functions available through one or more client or user interfaces (UIs). The UIs may be associated with a client device, such as a client device 106 using web client 110. The web client 110 may be in communication with the network-based marketplace 102 via a web server 122. The UIs may also be associated with a client device 108 using a programmatic client 112, such as a client application, or a third party server 114 (e.g., one or more servers or client devices) hosting a third party application 116. It can be appreciated that, in various embodiments, the client devices 106, 108, and/or the third party server 114 may be associated with a buyer, a seller, a third party electronic commerce platform, a payment service provider, or a shipping service provider, each in communication with the network-based marketplace 102 and optionally with each other. The buyers and sellers may be any one of individuals, merchants, or service providers, among other things.

The client devices 106 and 108 may be any of a variety of types of devices (e.g., a cellular telephone, a smart phone, a personal digital assistant (PDA), a personal navigation device (PND), a handheld computer, a tablet computer, a laptop computer, a desktop computer, a notebook computer, a wearable computing device such as glasses or a wristwatch, an multimedia device embedded in an automobile, a Global Positioning System (GPS) device, a data enabled book reader, or other type of movable device). The client devices 106 and 108 may interface via a connection 118 with a communication network 104 (e.g., the Internet or Wide Area Network (WAN)). Depending on the form of the client device 106 and 108, any of a variety of types of connections 118 and communication networks 104 may be used.

For example, the connection 118 may be Code Division Multiple Access (CDMA) connection, a Global System for Mobile communications (GSM) connection, or other type of cellular connection. Such a connection 118 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks). When such technology is employed, the communication network 104 may include a cellular network that has a plurality of cell sites of overlapping geographic coverage, interconnected by cellular telephone exchanges. These cellular telephone exchanges may be coupled to a network backbone (e.g., the public switched telephone network (PSTN), a packet-switched data network, or to other types of networks).

In another example, the connection 118 may be Wireless Fidelity (Wi-Fi, IEEE 802.11x type) connection, a Worldwide Interoperability for Microwave Access (WiMAX) connection, or another type of wireless data connection. In such an embodiment, the communication network 104 may include one or more wireless access points coupled to a local area network (LAN), a WAN, the Internet, or other packet-switched data network.

In yet another example, the connection 118 may be a wired connection, for example an Ethernet link, and the communication network 104 may be a LAN, a WAN, the Internet, or other packet-switched data network. Accordingly, a variety of different configurations are expressly contemplated.

FIG. 1 also illustrates a third party application 116 executing on a third party server 114 that may offer one or more services to users of the client devices 106 and 108. The third party application 116 may have programmatic access to the network-based marketplace 102 via the programmatic interface provided by an application program interface (API) server 120. In some embodiments, the third party application 116 may be associated with a vendor, a merchant, or any organizations that may conduct transactions with the users of the client devices 106 and 108. For some example embodiments, the third party application 116 may be associated with an online marketplace (e.g., eBay, Inc. of San Jose, Calif.).

Turning specifically to the networked-based marketplace 102, the API server 120 and a web server 122 are coupled to, and provide programmatic and web interfaces respectively to, one or more application servers 124. The application servers 124 host one or more marketplace applications 126, payment applications 128, and applicability indication applications 130. The application servers 124 may be coupled via these interfaces to the communication network 104, for example, via wired or wireless interfaces. The application servers 124 are, in turn, shown to be coupled to one or more database servers 132 that facilitate access to one or more databases 134. In some examples, the application servers 124 can access the databases 134 directly without the need for a database server 132. In some embodiments, the databases 134 may include databases both internal and external to the network-based marketplace 102.

The marketplace applications 126 may provide a number of marketplace functions and services to users that access the network-based marketplace 102. The payment applications 128 may likewise provide a number of payment services and functions to users. The payment applications 128 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 126. For some example embodiments, payment applications 128 generally enable transfer of values (e.g., funds, reward points, etc.) from an account associated with one party (referred to as a sender) to another account associated with another party (referred to as a receiver). To perform the value transfer, execution of the payment applications 128 may be based on one or more approval flows. This may require having access or the rights to initiate these approval flows and to use the services of a payment facilitator. One example of a payment facilitator is PayPal, Inc. of San Jose, Calif. Having access may not include having approval to transfer the values out of the sender's account, while having approval may implicitly include having access.

The applicability indication applications 130 may provide users of the marketplace 102 with indications of applicability for items presented to users. For example, the applicability indication applications 130 may generate an applicability indicator for a list of items provided to a user as a recommendation based on the user purchasing one or more items listed for sale on the network-based marketplace 102.

While the marketplace 102, payment, and applicability indication applications 126, 128, and 130 are shown in FIG. 1 to all form part of the network-based marketplace 102, it will be appreciated that, in alternative embodiments, the applicability indication applications 130 may form part of a service that is separate and distinct from the network-based marketplace 102. Further, while the system 100 shown in FIG. 1 employs a client-server architecture, the present inventive subject matter is, of course, not limited to such an architecture, and could equally well find application in an event-driven, distributed, or peer-to-peer architecture system, for example. The various modules of the application servers 124 may also be implemented as standalone systems or software programs, which do not necessarily have networking capabilities.

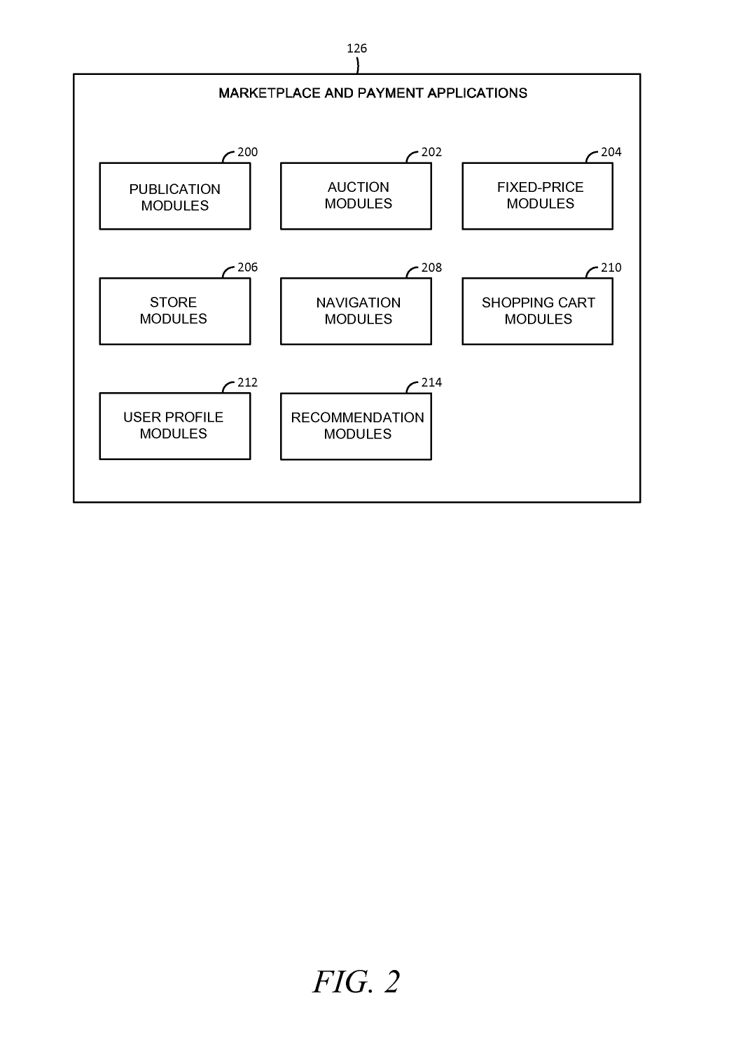

FIG. 2 is a block diagram illustrating an example embodiment of multiple modules forming the marketplace applications 126, which are provided as part of the network system 100. The modules of the marketplace applications 126 may be hosted on dedicated or shared server machines that are communicatively coupled to enable communications between server machines. Each of the modules 200-214 are communicatively coupled (e.g., via appropriate interfaces) to each other and to various data sources, so as to allow information to be passed between the modules 200-214 of the marketplace applications 126 or so as to allow the modules 200-214 to share and access common data. The various modules of the marketplace applications 126 may furthermore access one or more databases 134 via the database servers 132.

The marketplace applications 126 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 126 are shown to include at least one publication module 200 and one or more auction modules 202, which support auction-format listing and price setting mechanisms (e.g., English, Dutch, Vickrey, Chinese, Double, Reverse auctions etc.). The various auction modules 202 may also provide a number of features in support of such auction-format listings, such as a reserve price feature whereby a seller may specify a reserve price in connection with a listing, and a proxy-bidding feature whereby a bidder may invoke automated proxy bidding.

A number of fixed-price modules 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store modules 206 may allow sellers to group their item listings (e.g., goods and/or services) within a “virtual” store, which may be branded and otherwise personalized by and for the sellers. Such a virtual store may also offer promotions, incentives, and features that are specific and personalized to a relevant seller. In one embodiment, the listings and/or transactions associated with the virtual store and its features may be provided to one or more users.

Navigation of the network-based marketplace 102 may be facilitated by one or more navigation modules 208. For example, a search module may, inter alia, enable key word searches of listings published via the marketplace 102. A browser module may allow users via an associated UI to browse various category, catalogue, inventory, social network, and review data structures within the marketplace 102. Various other navigation modules 208 (e.g., an external search engine) may be provided to supplement the search and browsing modules.

In one embodiment, electronic shopping cart modules 210 are used to create an electronic shopping cart used by users of the network-based marketplace 102 to add and store items listed by the store modules 206. The electronic shopping cart modules 210 may also be used to “check out,” meaning a user may purchase items in the electronic shopping cart. The electronic shopping cart modules 210 may facilitate the transactions by automatically finding the items in the electronic shopping cart across at least one or all of a predefined set of vendors, a comparison shopping site, an auction site, and so forth. In various embodiments, the selection criteria for which vendor or vendors to purchase from may include, but is not limited to, criteria such as lowest cost, fastest shipping time, preferred or highest rated vendors or sellers, or any combination thereof.

As illustrated in FIG. 2, the marketplace applications 126 may also include one or more user profile modules 212, which are used to generate and maintain a user profile for each user of the networked system 100. Each user profile may be stored and maintained in database 134. Each user profile comprises a set of profile attributes describing aspects of a particular user. The set of profile attributes may correspond to demographic data, user preferences, and user activity. Accordingly, the user profile modules 212 may be configured to monitor, track, and record the activities and interactions of a user, using one or more devices (e.g., client device 106), with the various modules of the network system 100. The user profile modules 212 may store each user session as an activity set and maintain each activity set as part of the user profile. In some embodiments, the user preferences may be inferred by the user profile modules 212 from the user activity.

In some embodiments, the user profile modules 212 may work in conjunction with the navigation applications 208 to monitor and store the activity of the user associated with the searching and browsing of listings published via the network-based marketplace 102. Accordingly, the user profile may include a transaction history of the user. Transaction history may include information related to transactions for items or services offered for sale by a network-based marketplace 102. The transaction history information may, for example, include a description of an item or service purchased by the user, an identifier of the item or service, a category to which the item or service belongs, a purchase price, a quantity, or a number of bids.

In some embodiments, the user profile may include a list of social network connections of the user. For purposes of the present disclosure, a social network “connection,” also referred to as being “connected” on a social network, may include both a bi-lateral agreement between members of the social network as well as situations in which there is only a unilateral acknowledgement of the “connection.” In the bi-lateral agreement situation, both members of the “connection” acknowledge the establishment of the connection (e.g., friends). In the unilateral acknowledgement situation, a member may elect to “follow” or “watch” another member. In contrast to bi-lateral agreement, the concept of “following” another member typically is a unilateral operation because it may not require acknowledgement or approval by the member that is being followed.

The demographic data included as part of the user profile may include information describing one or more characteristics of a user. Demographic data may, for example, include gender, age, location information, employment history, education history, contact information, familial relations, or user interests.

As illustrated in FIG. 2, the marketplace applications 130 may include one or more recommendation modules 214, which may provide recommendation services and functions to users. In some embodiments, the recommendation modules 214 may receive requests for recommendations, and, in turn, provide a recommendation to the user based on information contained in the user's corresponding user profile. In some embodiments, the recommendation modules 214 may automatically generate and provide a recommendation based on the activity of the user. The recommendations provided by the recommendation modules 214 may contain one or more items (e.g., products offered for sale, articles, blogs, movies, social network connections, etc.) that may potentially interest a user. The recommendations may, for example, be based on previous items purchased by the user or a social network connection of the user, a web page viewed by the user, or an item given favorable feedback by the user or a social connection of the user.

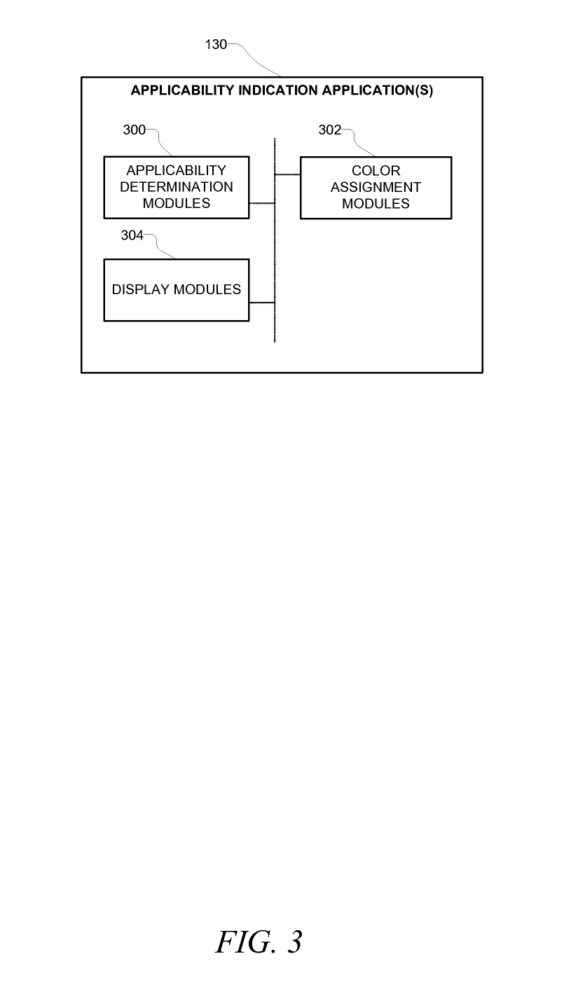

FIG. 3 is a block diagram illustrating an example embodiment of multiple modules forming the applicability indication applications 130, which are provided as part of the network system 100. The applicability indication applications 130 are shown as including applicability determination modules 300, color assignment modules 302, and display modules 304, all configured to communicate with each other (e.g., via a bus, shared memory, a switch, or APIs). The various modules of the applicability indication applications 130 may furthermore access one or more databases 134 via the database servers 132.

Any one or more of the modules described herein may be implemented using hardware (e.g., a processor of a machine) or a combination of hardware and software. For example, any module described herein may configure a processor to perform the operations described herein for that module. Furthermore, according to various example embodiments, modules described herein as being implemented within a single machine, database, or device may be distributed across multiple machines, databases, or devices. In some embodiments, the modules of the applicability indication applications 130 may be hosted on dedicated or shared server machines that are communicatively coupled to enable communications between server machines.

As illustrated in FIG. 3, applicability indication applications 130 may include one or more applicability determination modules 300, which may determine an applicability score for one or more data items. To this end, the applicability determination modules 300 may access a user profile from the database 134 and a set of item attributes corresponding to one or more data items. The one or more data items may form part of a list of data items returned by the navigation modules 208 in response to a user query, or part of a recommendation provided to the recommendation modules 214. The set of item attributes describe certain characteristics or properties of the data item. For example, the data item may be an item offered for sale on the network-based marketplace 102. In this example, the set of item attributes may, for example, correspond to an item type, size, weight, dimension, color, brand, manufacturer, price, shipping cost, shipping time, make, model, date of manufacture, or the like. In another example, the data item may be an image included in a list of search results. In this example, the set of item attributes may, for example, correspond to file size, image type, file type, image colorization, or the like. In yet another example, the data item may be a movie title returned to the user as part of a recommendation. In this example, the set of item attributes may, for example, correspond to a title, a genre, a release date, an actor or actress, a director, a running time, a rating, or the like.

The applicability score may provide a measure of the relevance of a particular data item to a particular user. In some embodiments, the determination of the applicability score for a particular data item may comprise applying a relevance algorithm to the one or more profile attributes of a user profile and a set of item attributes of the data item to determine the relevance of the particular data item. In some embodiments, the relevance algorithm may be a distance algorithm applied to the one or more profile attributes of the user profile and the set of item attributes of the data item to determine a distance between the user profile and the particular data item. The distance between the user profile and the particular item is a measure of the similarity of the particular item to the information contained in the user profile.

In some embodiments, the determining of the applicability score for a particular data item by the applicability determination modules 300 may comprise applying a distance algorithm to a first set of item attributes and a second set of item attributes. The first set of item attributes may correspond to a first data item referenced in an activity set maintained as part of the user profile of the user. The second set of item attributes may correspond to a second data item included in a recommendation generated by recommendation modules 214. For example, during an electronic commerce session a user may add a particular smart phone cover to an electronic shopping cart (e.g., provided by shopping cart modules 210) without purchasing the item. This information may be tracked and stored by the user profile modules 212 as an activity set maintained as part of the user's profile. In this example, a recommendation may be generated by the recommendation modules 214 and may include a new smart phone cover that is similar to the smart phone cover added to the electronic shopping cart of the user. Continuing with this example, the applicability determination modules 300 may apply a distance algorithm to the set of item attributes corresponding to the first smart phone cover (e.g., the smart phone cover added to the electronic shopping cart) and the set of item attributes corresponding to the second smart phone cover (e.g., the new smart phone cover) to determine the applicability score of the second smart phone cover.

As illustrated in FIG. 3, the applicability indication applications 130 may include one more color assignment modules 302, which may assign a set of color values to a data item based on the applicability score of the data item. The set of color values correspond to coordinates within a color space. In some embodiments, the color space may be based on the red, green, and blue (RGB) color model. Consistent with these embodiments, the color space may, for example, be a Hue Saturation Value (HSV), Hue Saturation Lightness (HSL), sRGB, Adobe RGB, or ProPhoto RGB color space. In another embodiment, the color space may be based on the Cyan, Magenta, Yellow and Key (CMYK) color model.

The assigning of the set of color values to a data item by the color assignment modules 302 may further comprise assigning each item attribute of the set of item attributes to an axis in the color space. The color assignment modules 302 may then assign a desirability weight to each of the set of item attributes, or to a group of item attributes of the set of item attributes. The desirability weight assigned by the color assignment modules 302 to a particular item attribute may be based on user preferences stored in a user profile. For example, the user preferences of a particular user may indicate an affinity for “Free Shipping” as opposed to “Fast Shipping.” As such, the color assignment modules 302 may assign a higher desirability weight to an item attribute for “Free Shipping” than the item attribute for “Fast Shipping.” The assigning of the set of color values to a data item by the color assignment modules 302 may further comprise mapping the applicability score of a particular data item to a set of coordinates within the color space. The set of coordinates to which the applicability score is mapped corresponds to the set of color values assigned to the target data item.

As illustrated in FIG. 3, the applicability indication applications 130 may include one or more display modules 304. The display module 306 may control information or data that is provided to client systems for display on client device 106. The display module 304 may be configured to generate and provide instructions to present web pages, user interfaces, search results, recommendation results, and other information retrieved from the database 134.

In some embodiments, display modules 304 may be configured to generate one or more item view interfaces, which may include a list of data items retrieved for a user in response to a search query or as part of a recommendation. The one or more item view interfaces generated by the display modules 304 may include an applicability indicator for each data item included in the list of data items. Each applicability indicator indicates the applicability or relevance of a particular data item to a user by way of color. The color of each applicability indicator corresponds to the set of color values assigned to the respective item by the color assignment modules 302. The display modules 306 may transmit instructions to the client device 106, which cause the client device 106 to present the one or more item views to the user.

It will be appreciated that one or more of the various example modules of the applicability indication applications 130 may be combined into a single module. Further, in some embodiments, the one or more modules may be omitted and additional modules may also be included. Additionally, while the modules of FIG. 3 are discussed in the plural sense, it is noted that a single version of the module may be utilized.

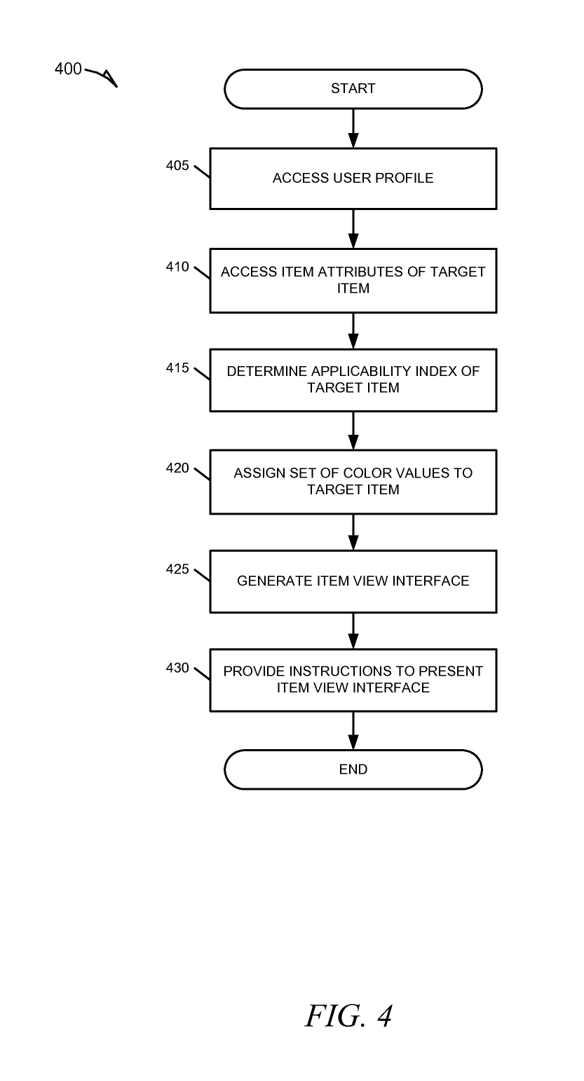

FIG. 4 is a flowchart illustrating an example method 400 of providing an applicability indicator for a particular data item. In this example, the method 400 may include operations such as accessing a user profile at operation 405, accessing a set of item attributes at operation 410, determining an applicability score at operation 415, assigning color values at operation 420, generating an item view at operation 425, and providing instructions to display the item view at operation 430.

At operation 405, a user profile is accessed by the applicability determination modules 300. The user profile may comprise one or more profile attributes. In some embodiments, the user profile may include one or more activity sets, which are logs of the activity of the user on the network system 100. The activity sets may, for example, include a keyword search utilizing the functionality of the navigation modules 208. In another example, the activity set may include an electronic commerce session of the user on the network-based marketplace 102. The electronic commerce session may, for example, include viewing item listings, adding one or more items to a wish list, adding one or more items to an electronic shopping cart, or purchasing a particular item.

At operation 410, a set of item attributes corresponding to an item may be accessed by the applicability determination modules 300. In some embodiments, the item may be an item related to a previous ecommerce session of the user. In some embodiments, the item may be a data item included in a list of data items retrieved based on a key word search performed by the user. In some embodiments, the item may be an item included in a recommendation generated by recommendation module 214.

At operation 415, the applicability determination modules 300 determine an applicability score for the item. The applicability score provides a measure of the relevance of the item to the user with respect to the information comprising the user profile. In some embodiments, the determination of the applicability score may comprise applying a distance algorithm to the set of item attributes and the profile attributes of the user profile to determine a distance between the user profile and the item. The resulting distance may be used as the applicability score for the item. The applicability score may comprise a single value, or in some embodiments, a set of values.

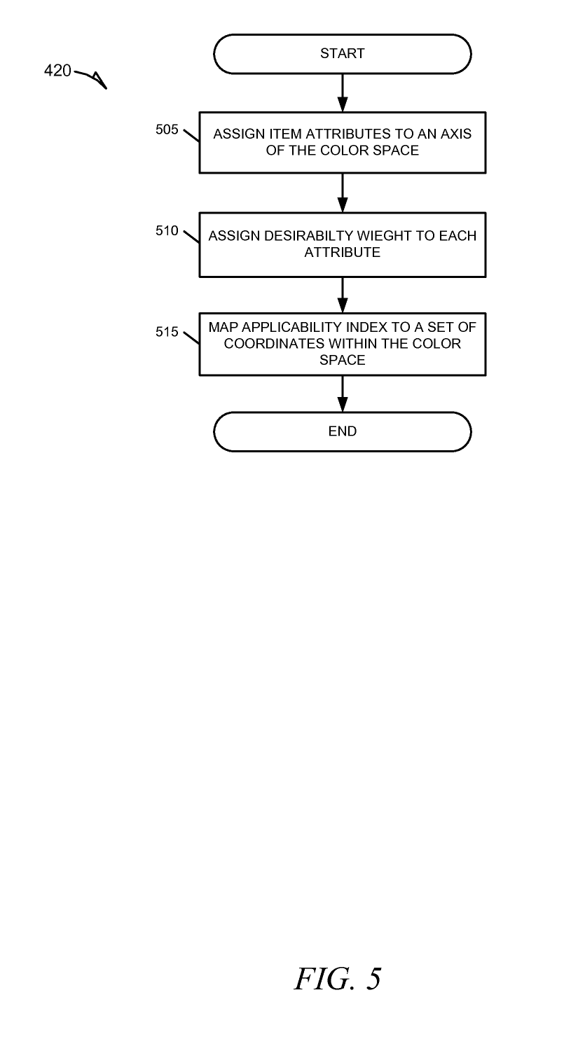

At operation 420, the color assignment modules 302 may assign a set of color values to the item based on the applicability score determined at operation 415. The set of color values may correspond to coordinates with a color space. Further details of operation 420 are discussed below with reference to FIG. 5.

At operation 425, the display modules 304 may generate an item view interface. The item view interface may include a description of the item (e.g., text, images, etc.) and an applicability indicator. The applicability indicator provides a visual indication of the applicability of the item to the user. The applicability indicator may convey the applicability of the item to the user using color. The color of a particular applicability indicator may correspond to the set of color values assigned to the item by the color assignment modules 302. In some embodiments, the applicability indicator may comprise a solid border outlining the description of the item. In some embodiments, the applicability indicator may comprise the text of the description of the item. In some embodiments, the color indicator may be in the form of a simple shape (e.g., square, circle, triangle, etc.) and the color indicator may be presented in conjunction with the description of the item. At operation 430, the display modules 304 may provide instructions to the client device 106 to be presented the item view interface on the display of the client device 106.

FIG. 5 is a flowchart illustrating an example method of operation 420 of assigning a set of color values to a item. In this example, the operation 420 may include operations such as assigning each item attribute to an axis in the color space at operation 505, assigning a desirability weight to each item attribute at operation 510, and mapping the applicability score to a set of coordinates within the color space at operation 515.

At operation 505, each item of the set of item attributes are assigned to an axis of the color space. Each axis of the color space may correspond to a particular color or hue. For example, in a three-dimensional color space based on the CMYK color model, the X axis may correspond to an amount of magenta, the Y axis may correspond to an amount of cyan, and the Z axis may correspond to an amount of yellow. The resulting space created by the three axes may provide a unique position (e.g., a point defined by a set of coordinates) for each possible color that may be created via various combinations of cyan, magenta, and yellow.

At operation 510, the color assignment modules 302 may assign a desirability weight to each item attribute of group of attributes such that the impact of particular item attributes in the assignment of the set of color values to the item is increased. The desirability weight assigned to each axis may be based on the information (e.g., user preferences) comprising the user profile so that the desirability weight assigned to particular item attributes is in accordance with user preferences. For example, a user shopping for laptop computers may have an affinity for a particular brand while being unconcerned with the price of the laptop. These preferences may be captured by the user profile modules 212 in the corresponding user profile. In this example, the desirability weight assigned to the item attribute for the brand of the item may be greater than the item attribute for the price of the item.

At operation 515, the color assignment modules 302 may map the applicability score to a set of coordinates within the color space. The set of coordinates within the color space correspond to the set of color values assigned to the item by the color assignment modules 302.

An illustrative example of the operations comprising operation 420 is as follows. A user profile corresponding to a particular user may comprise an activity set including an ecommerce session related to smart phones. A recommendation for smart phones may be generated by the recommendation modules 214. The recommendation may include a list of items (e.g., a list of smart phones) that includes the item (e.g., a particular smart phone). The item may have a set of item attributes corresponding to price, brand, and condition (e.g., new or used).

Following the above example, each of these attributes may be assigned to a respective axis of a color space based on the RGB color model (e.g., operation 505). Consequently, the price attribute may be assigned to the axis corresponding to red, the brand attribute may be assigned to the axis corresponding to green, and the condition attribute may be assigned to the axis corresponding to blue. The user profile may indicate that the user is primarily concerned with the brand of the item, fairly concerned with the condition, and indifferent to the price of the item. Accordingly, the axis corresponding to the brand is assigned the highest desirability weight, the axis corresponding to condition may be assigned a slightly lower desirability weight, and the axis corresponding to price may be assigned no desirability weight (e.g., operation 510). The item is then assigned to a particular color within the color space (e.g., to a set of coordinates) based on the applicability score of the item (e.g., operation 515). If the brand of the item is close (e.g., a short distance) to the brand sought out by the user, then the resulting color assigned to the item will be predominantly green. If the condition of the item is the condition sought by the user (e.g., new), then the resulting color assigned to the item may have, at least, a hint of blue.

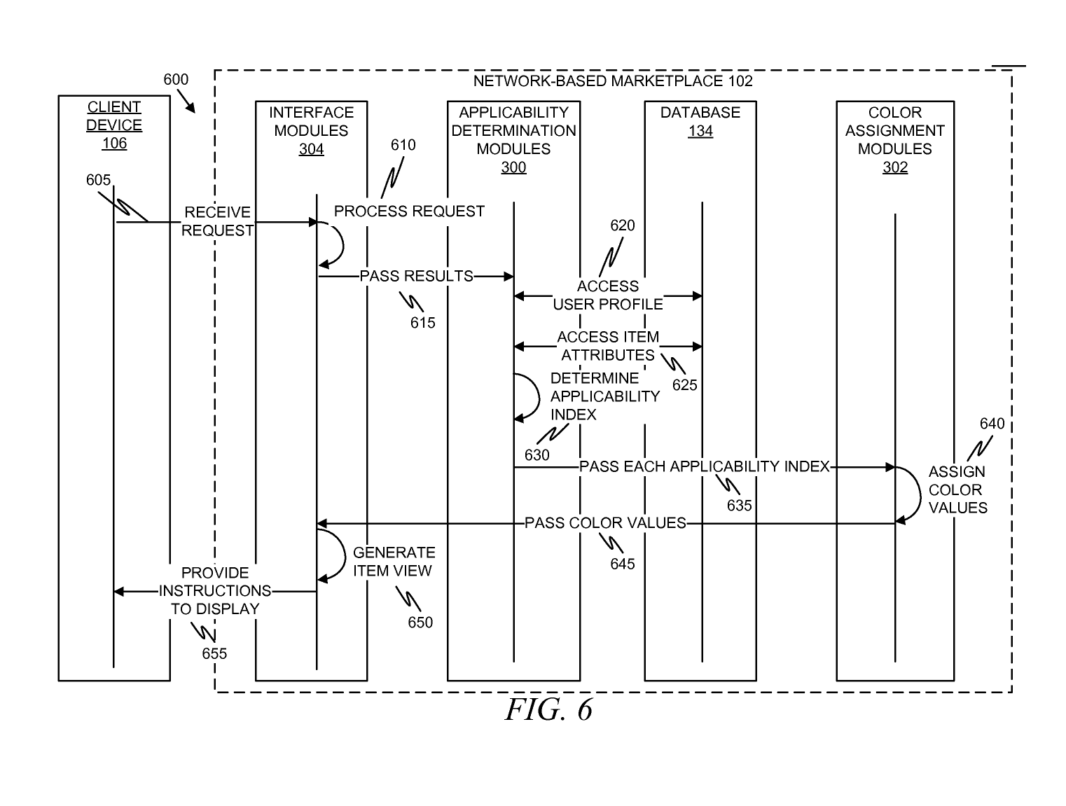

FIG. 6 is an interaction diagram illustrating an example method 600 of providing an applicability indicator for a item. In particular, FIG. 6 illustrates interactions between various components of the network system 100, according to an example embodiment. Specifically, FIG. 6 illustrates interactions of the client device 106, the interface modules 304, the applicability determination modules 300, the database 134, and the color assignment modules 302.

At operation 605, a request is received by the interface modules 304 from the client device 106. The request may be, for example, a request to view a marketplace listing of a particular item. It should be appreciated that operations 605 and 610 may not be included in alternative embodiments. Further, operations 605 and 610 are depicted in FIG. 6 as being included in the method 600 merely to provide context for the subsequent operations.

At operation 615, the results of the processing of the user request are provided to the applicability determination modules 300. The results may comprise a list of data items generated as part of a recommendation in response to the user requesting to view a particular item listing. At operation 620, the applicability determination modules 300 may access a user profile stored in the database 134. The user profile may correspond to the user operating client device 106. The user profile may comprise a set of profile attributes describing aspects of the user (e.g., user demographics, preferences, behavior, activities, etc.). At operation 625, the applicability determination modules 300 may access a set of item attributes for each data item included in the list of data items. The applicability determination modules 300 may determine an applicability score for each of the data items of the list of data items at operation 630. In some embodiments, the determination of the applicability score may comprise applying a distance algorithm to each set of item attributes of each respective data item and the set of item attributes corresponding to the item listing viewed by the user. Each respective index is then provided to the color assignment modules 302 by the applicability determination modules 300 at operation 635.

At operation 640, the color assignment modules 302 may assign a set of color values to each data item of the list of data items based on the respective item attributes of each data item. The color values assigned to each data item correspond to a set of coordinates within a color space. Consequently, the set of color values denote a particular color located within the color space. At operation 645, the color assignment modules 302 provide each set of color values to the display modules 304.

The display modules 304, in turn, generate an item view interface at operation 650. The item view interface may comprise the list of data items, including a description for each, along with an applicability indicator for each data item. Each respective applicability indicator is colored in accordance with the respective set of color values assigned to each data item. As a result, the color of each applicability indicator provides the user with an indication of the applicability of the corresponding data item to the user. At operation 655, the interface modules provide instructions to the client device 106 that cause the client device 106 to display the item view interface.

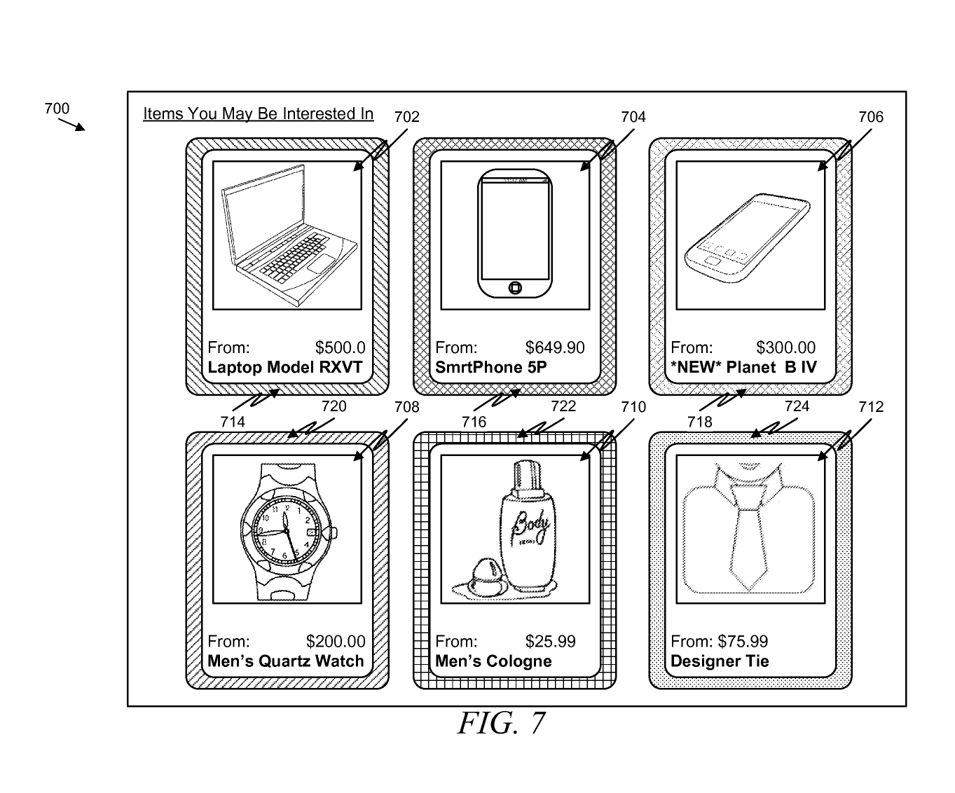

FIG. 7 is an interface diagram illustrating a portion of an item view interface 700, according to an example embodiment. As illustrated in FIG. 7, the item view interface 700 may include a collection of items. In particular, the collection of items includes items 702-712. Each of the items 702-712 may be an item offered for sale on the network-based marketplace 102. The collection of items may form part of one or more recommendations generated by the recommendation modules 214 for a particular user. For example, items 702-706 may be included in a recommendation generated by the recommendation modules 214 based on a user viewing an item listing (e.g., hosted on the network-based marketplace 102) for a smart phone. Similarly, the items 708-712 may be included in a recommendation generated by the recommendation modules 214 based on a user's corresponding user profile including an activity set related to men's apparel.

Each of the items 702-712 may include applicability indicators 714-724, respectively. The applicability indicators 714-724 may be presented as a border around each respective item 702-712. The applicability indicators 714-724 may provide a visual indication to the user of the applicability of each of the items 702-712 to the user. To this end, each of the applicability indicators 714-724 is colored to convey the applicability of the items to the user. The color of each applicability indicator 714-724 corresponds to the set of color values assigned to each item 702-712 by color assignment modules 302 in accordance with methodologies discussed herein. It should be appreciated that in alternative embodiments, the applicability indicators 714-724 may be a colored shape, set of text, or other mark that is presented in conjunction with each corresponding item 702-712.

### Example Client Device

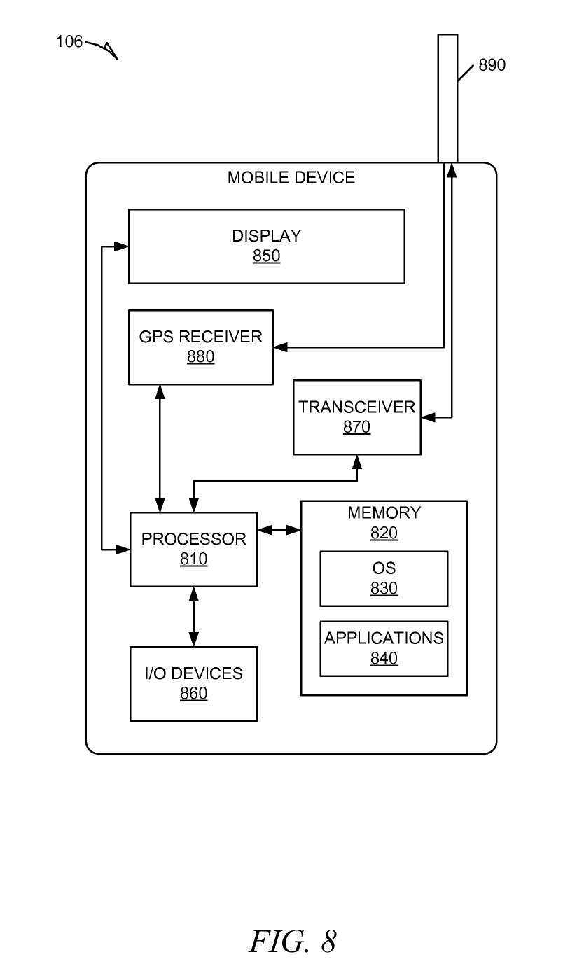

FIG. 8 is a block diagram illustrating a client device 106, such as a mobile device, according to an example embodiment. The client device 106 may include a processor 810. The processor 810 may be any of a variety of different types of commercially available processors suitable for mobile devices (e.g., an XScale architecture microprocessor, a Microprocessor without Interlocked Pipeline Stages (MIPS) architecture processor, or another type of processor). A memory 820, such as a random access memory (RAM), a Flash memory, or other type of memory, is typically accessible to the processor 810. The memory 820 may be adapted to store an operating system (OS) 830, as well as application programs 840, such as a mobile location enabled application that may provide location based services (e.g., physical location check-in) to a user. The processor 810 may be coupled, either directly or via appropriate intermediary hardware, to a display 850 and to one or more input/output (I/O) devices 860, such as a keypad, a touch panel sensor, a microphone, and the like. Similarly, in some embodiments, the processor 810 may be coupled to a transceiver 870 that interfaces with an antenna 890. The transceiver 870 may be configured to both transmit and receive cellular network signals, wireless data signals, or other types of signals via the antenna 890, depending on the nature of the client device 106. In this manner, the connection 118 with the network 104 may be established. Further, in some configurations, a GPS receiver 880 may also make use of the antenna 890 to receive GPS signals.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a FPGA or an ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site, or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

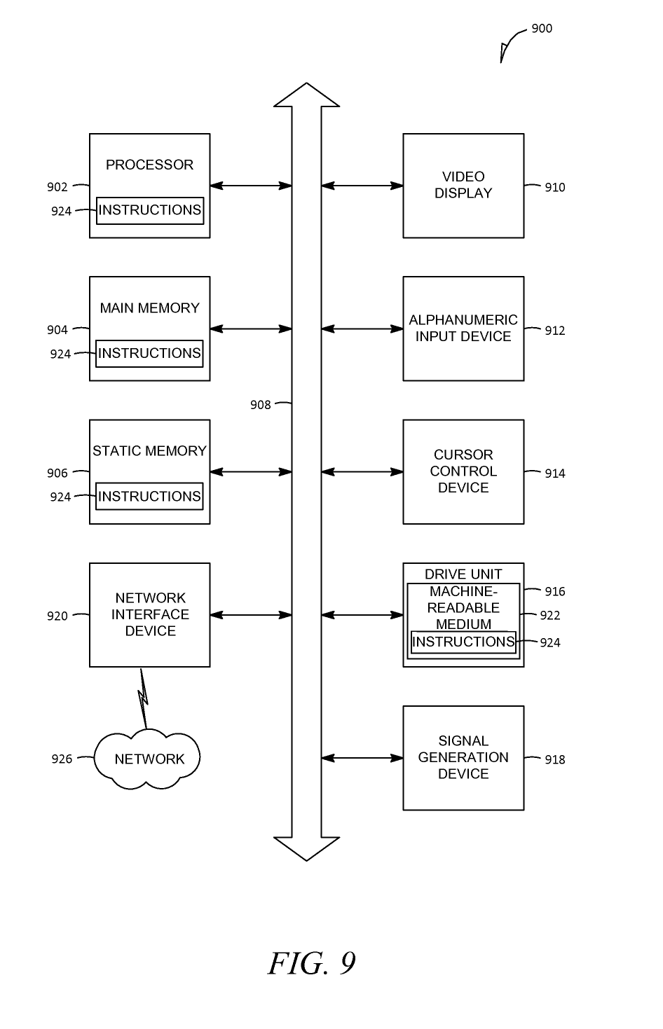

FIG. 9 is a block diagram of machine in the example form of a computer system 900 within which instructions 924 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a UI cursor control device 914 (e.g., a mouse), a disk drive unit 916, a signal generation device 918 (e.g., a speaker), and a network interface device 920.

### Machine-Readable Medium

The disk drive unit 916 includes a machine-readable medium 922 on which is stored one or more sets of data structures and instructions 924 (e.g., software) embodying or used by any one or more of the methodologies or functions described herein. The instructions 924 may also reside, completely or at least partially, within the main memory 904, static memory 906, and/or within the processor 902 during execution thereof by the computer system 900, with the main memory 904 and the processor 902 also constituting machine-readable media.

While the machine-readable medium 922 is shown in an example embodiment to be a single medium, the term “machine-readable medium” may include a single medium or multiple media (e.g., a centralized or distributed database, and/or associated caches and servers) that store the one or more data structures or instructions 924. The term “machine-readable medium” shall also be taken to include any tangible medium that is capable of storing, encoding, or carrying instructions for execution by the machine and that cause the machine to perform any one or more of the methodologies of the present disclosure, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example, semiconductor memory devices (e.g., erasable programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

### Transmission Medium

The instructions 924 may further be transmitted or received over a communications network 926 using a transmission medium. The instructions 924 may be transmitted using the network interface device 920 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium that is capable of storing, encoding, or carrying instructions 924 for execution by the machine, and includes digital or analog communications signals or other intangible media to facilitate communication of such software.

Although the embodiments of the present invention have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated references should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” and “third,” and so forth are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed:

1. A system comprising:
a processor configured by an applicability determination module to access a user profile and a set of item attributes corresponding to an item, the user profile including a profile attribute describing a user, the applicability module further configured to determine, using the processor of the machine, an applicability score corresponding to the item using the set of item attributes and the profile attribute, the applicability score, the applicability score providing a measure of relevance of the item to the user;
a color assignment module configured to assign a set of color values to the item using the applicability score; and
a user interface module configured to provide instructions to a client device which cause a view of the item to be presented on the client device, the view of the item including an applicability indicator, the applicability indicator having a color corresponding to the set of color values.

2. The system of claim 1, wherein the applicability module is further to access a plurality of additional items, each of the plurality of items having a set of item attributes, and the applicability module is further configured to determine an additional applicability score for each of the items of the plurality of items;
wherein the color assignment module is further configured to assign an updated set of color values to each of the plurality of items; and
wherein the user interface module is further configured to provide instructions to the client device which cause an updated view to be presented on the client device, the updated view including the item, the plurality of additional items, and a plurality of additional color indicators, the plurality of additional color indications corresponding to a respective item of the plurality of items and having a color corresponding to the updated set of color values.

3. The system of claim 1, wherein the user interface module is further configured to receive a user request, from the client device, for an item recommendation, wherein the accessing the plurality of items is in response to the receiving of the user request.

4. The system of claim 1, wherein the user profile further includes an activity set corresponding to the user, the activity set related to activity of the user on a networked information system.

5. The system of claim 4, wherein the activity set includes performing a user query.

6. The system of claim 1, wherein the determining of the applicability score between the user profile and the item comprises applying a distance algorithm to the one or more profile attributes and the set of item attributes to determine a distance between the user profile and the item.

7. The system of claim 7, wherein the color space is based on a red, green and blue (RGB) color model.

8. The system of claim 1, wherein the assigning the set of color values to the item comprises:
assigning each item attribute of the set of item attributes to an axis in a color space;
assigning a desirability weight to each axis of the color space; and
mapping the applicability score to a set of coordinates within the color space, the set of coordinates corresponding to the set of color values.

9. A method comprising:
accessing a user profile, the user profile including a profile attribute describing a user;
accessing a set of item attributes corresponding to an item;
determining, by a processor of a machine, an applicability score for the item based on the set of item attributes and the one or more profile attributes;
assigning a set of color values to the item using applicability score, the set of color values corresponding to coordinates within a color space; and
providing instructions that cause the presentation of a view of the item on a client device, the view of the item including an applicability indicator, the applicability indicator having a color corresponding to the set of color values.

10. The method of claim 9, further comprising:
accessing a plurality of additional items, each of the plurality of items having a set of item attributes;
determining an additional applicability score for each of the items of the plurality of items;
assigning an updated set of color values to each of the plurality of items; and
presenting the user with an updated view, the updated view including the item, the plurality of additional items, and a plurality of additional color indicators, the plurality of additional color indications corresponding to a respective item of the plurality of items and having a color corresponding to the updated set of color values.

11. The method of claim 9, further comprising:
receiving a user request, from a client device operated by the user, the request including a keyword search;
generating a list of search results in response to receiving the user request;
wherein the item is included in the list of search results.

12. The method of claim 9, wherein the user profile further includes an activity set corresponding to the user, the activity set related to activity of the user on a networked information system.

13. The method of claim 12, wherein the activity set includes an adding an unpurchased item to an electronic shopping cart, the unpurchased item being related to the item.

14. The method of claim 9, wherein the determining of the applicability score for the item comprises applying a distance algorithm to the one or more profile attributes and the set of item attributes to determine a distance between the user profile and the target item.

15. The method of claim 9, wherein the color space is based on a red, green and blue (RGB) color model.

16. The method of claim 9, wherein the set of color values represents cylindrical-coordinates of a point in an (RGB) color model.

17. The method of claim 9, wherein the assigning the set of color values to the item comprises:
assigning each item attribute of the set of item attributes to an axis in the color space;
assigning a desirability weight to each item attribute of the set of item attributes; and
mapping the applicability score to a set of coordinates within the color space, the set of coordinates corresponding to the set of color values.

18. The method of claim 17, wherein the desirability weight is determined based on the user profile.

19. The method of claim 9, wherein the applicability indicator is presented as a border and the item is presented within the border.

20. A non-transitory machine-readable storage medium embodying instructions that, when executed by a machine, cause the machine to perform operations comprising:
accessing a user profile, the user profile including a profile attribute describing a user;
accessing a set of item attributes corresponding to an item;
applying a distance algorithm to the profile attribute and the set of item attributes to determine a distance between the user profile and the item;
assigning a set of color values to the item using the distance, the set of color values corresponding to coordinates within a color space; and
providing instructions that cause the presentation of a view of the item on a client device, the view of the item including an applicability indicator, the applicability indicator having a color corresponding to the set of color values.
